(19) United States
(12) Patent Application Publication
(10) Pub. No.: US 2022/0214221 A1
(43) Pub. Date: Jul. 7, 2022

(54) Phosphor Thermometry Imaging System and Control System

(71) Applicant: Photon Control Inc., Richmond (CA)

(72) Inventors: Timothy BRAY, Richmond (CA); Yuri SIKORSKI, Richmond (CA); Yuriy SYVENKYY, Richmond (CA); Alborz AMINI, Richmond (CA); Esmaeil RAHIMI JANIABADI, Richmond (CA)

(73) Assignee: Photon Control Inc., Richmond (CA)

(21) Appl. No.: 17/703,027

(22) Filed: Mar. 24, 2022

Related U.S. Application Data
(63) Continuation of application No. PCT/CA2020/051623, filed on Nov. 26, 2020.
(60) Provisional application No. 62/940,504, filed on Nov. 26, 2019.

(51) Int. Cl. G01J 5/02; G01J 5/08

(52) U.S. Cl. CPC G01J 5/026; G01J 2005/0077; G01J 5/0896

(57) ABSTRACT

The following provides a system and method for 2-D thermal imaging of phosphor coated surfaces. The system and method enable increased temperature measurement accuracy and speed of data analysis by implementing a control system that controls simultaneously an illumination system and an image capture device including a high speed camera. More particularly, the control system can control the illumination system and the camera to acquire images when emitted light intensity ranges are in a desired range to improve temperature measurement accuracy, and to increase the speed of data processing.

### CROSS-REFERENCE TO RELATED APPLICATION(S)

This application is a Continuation of PCT Application No. PCT/CA2020/051623 filed on Nov. 26, 2020 and claims priority to U.S. Provisional Patent Application No. 62/940,504 filed on Nov. 26, 2019, the entire contents of which are incorporated herein by reference.

### TECHNICAL FIELD

The following relates generally to thermal imaging using phosphor thermometry, and more particularly to systems and methods for generating high resolution 2-D thermal images of phosphor-coated surfaces.

### BACKGROUND

In many semiconductor manufacturing steps, wafer temperature is an important process parameter. For example, in plasma etching, small temperature variations can cause considerable changes in etching rates or critical dimension (CD) uniformity, thereby resulting in yield loss.

A common technique for measuring semiconductor wafer temperature is phosphor thermometry. Phosphor thermometry generally includes three steps, namely: excitation, phosphor decay, and analysis. The excitation phase involves stimulating phosphor with light from an external light source to cause luminescence of the phosphor. During the phosphor decay phase, the external light source is switched off, and the phosphor releases energy absorbed from the external light source. This release process takes place in an exponential manner with a time constant known as “decay time” which is a function of temperature. In the analysis phase, the decay time can be observed and translated into a temperature.

Phosphor thermometry is often carried out using contact phosphor-based temperature sensors. These sensors operate by remote, optical excitation of the phosphor and subsequent analysis of the re-emitted, temperature-dependent optical signal. A single, point-based measurement can be implemented using, for example, a fiber optic delivery system with a single photodetector. Multiple single point measurements can be used to build a temperature profile across a surface such as on a wafer chuck and thus the water itself. However, the need for physical installation of such probes can result in space constraints, and thus can limit the number of accessible measurement points on the chuck. A method of addressing this issue is to implement 2-D thermal imaging.

To create a 2-D temperature profile of an object, the decay time of phosphor is measured at as many points on the object surface as possible. Typically, decay times are calculated by measuring signal intensity multiple times and fitting an exponential curve to the acquired data points. Decay times can depend on the phosphor used, and can range from, for example, 2000 μs-4000 μs. Such short decay times can necessitate the use of high-speed cameras and can require considerable data processing power. In known methods, the camera, or image capturing device (ICD) is independent of the lighting system, thereby causing a number of complexities. For example, this independence can necessitate additional data processing time to determine the status of the illumination system, perform manual calibration of the illumination system and ICD with no feedback, and manual activation of the ICD. This, in turn, can result in the capture of unnecessary data which typically needs to be filtered out during data processing, further increasing processing time.

In view of the foregoing, an object of the following is to develop a method and system for 2-D thermal imaging of phosphor-coated objects that addresses one or more of the above-noted issues or drawbacks.

### SUMMARY

The following provides a system and method for 2-D thermal imaging of phosphor coated surfaces. The system and method enable increased temperature measurement accuracy and speed of data analysis by implementing a control system that controls simultaneously an illumination system and an image capture device including a high speed camera. More particularly, the control system can control the illumination system and the camera to acquire images when emitted light intensity ranges are in a desired range to improve temperature measurement accuracy.

In one aspect, there is provided a method for two-dimensional (2-D) thermal imaging of a surface having phosphor thereon, the method comprising: illuminating the surface with light having an excitation intensity, to induce phosphorescence of the phosphor to generate emitted light; measuring an intensity of the emitted light; if the intensity of the emitted light is less than a pre-determined threshold intensity, repeating the illuminating operation, or increasing the excitation intensity and repeating the measuring operation; if the intensity of the emitted light is equal to or greater than the pre-determined threshold intensity, turning off the light source; capturing a plurality of images after a delay time and/or when the intensity is less than a pre-determined maximum returned intensity; calculating, from the plurality of images, a decay lifetime of the phosphor at a number of points on the surface; and translating the decay lifetime for each point into a temperature to create a 2-D thermal image of the surface.

In another aspect, there is provided a phosphor thermometry system for carrying out the above method. The phosphor thermometry system includes an image capture device (ICD) positioned to capture the plurality of images of the surface; a computing device configured to receive the plurality of images from the ICD and translate data from the images into a 2-D thermal image; an illumination system including at least one light source positioned to illuminate the surface; a control system connected to the illumination system and the ICD, the control system configured to determine the intensity of the emitted light by operating the camera store and compare the pre-determined threshold intensity and/or the pre-determined maximum returned intensity to the emitted light intensity provide power to the illumination system based at least on the intensity of the emitted light; and operate the ICD to capture the plurality of images.

### BRIEF DESCRIPTION OF THE DRAWINGS

Embodiments will now be described with reference to the appended drawings wherein:

FIG. 1 is a schematic diagram of a system for 2-D thermal imaging of a semiconductor wafer by light-emitting diode (LED)-induced luminescence phosphor thermometry.

FIG. 2A is an example illustration of the ICD shown in FIG. 1.

FIG. 2B is an example illustration of the ICD shown in FIGS. 1 and 2A but including light intensity detectors.

FIG. 3 is a block diagram showing a control system for simultaneously operating the ICD and the illumination system.

FIG. 4 is a graph showing an example embodiment of the illumination system and ICD being controlled by the control system of FIG. 3.

FIG. 5 is a basic flow chart illustrating a method for controlling the imaging system shown in FIG. 1 with the control system shown in FIG. 3.

FIG. 6 is a flow chart illustrating a method for controlling the imaging system shown in FIG. 1 with the control system shown in FIG. 3.

### DETAILED DESCRIPTION

The following provides a 2-D thermal imaging system for carrying out LED-induced luminescence phosphor thermometry. The system described herein includes a control system that can control an illumination system and an ICD simultaneously to provide increased accuracy and data analysis speed as compared to known systems.

The 2-D thermal imaging system of the present disclosure is discussed in the context of measuring semi-conductor wafer temperature; however, it can be appreciated that the system can be applied to applications that involve measuring temperature or other attributes of other surfaces coated with phosphor. For example, the phosphor composition can be tuned to be sensitive to concentrations of certain gases and to ambient pressure, and therefore such attributes can be measured without needing to physically access the wafer. Avoiding physically accessing the wafer can help to maintain the environmental conditions in the processing chamber. For example, yttrium oxide doped with europium (Y2O3:Eu) shows a strong sensitivity to oxygen concentration in the surrounding gas phase (e.g., the chamber environment).

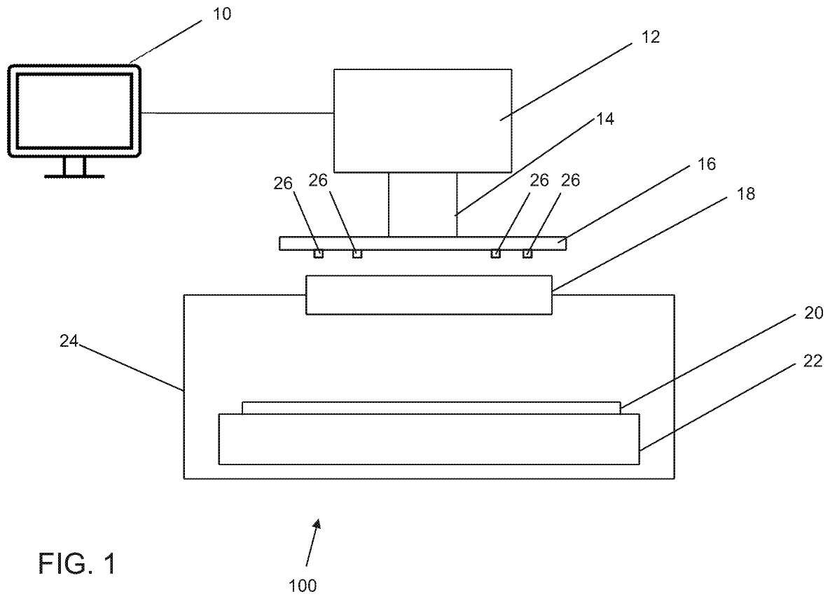

Turning to FIG. 1, illustrated is an example embodiment of a phosphor thermometry imaging system 100 for measuring the temperature of a semiconductor wafer 22 having a phosphor coating thereon 20. The system 100 includes a data analysis system 10, an ICD 12, an illumination system 16, and a semiconductor etching process chamber 24. The data analysis system 10 can be provided using a general purpose or specialized computing device (e.g., personal computer) and/or can include or otherwise provide other computing functionality such as a control system, calibration system, network connectivity, programming capabilities (e.g., for the ICD 12), etc. The ICD 12 is preferably a high-speed camera that incorporates a charge-coupled device (CCD) detector. The ICD 12 comprises a lens 14 positioned to receive, through a window 18 provided in the top of the chamber 24, light emitted by the phosphor coating 20, and to adjust the focus of the emitted light on a photoactive region within the ICD 12. A filter (not shown) can be provided between the lens 14 and the window, or between the lens 14 and the ICD 12. Such a filter can be used to filter out unwanted light, such as ambient or reflected light, and thus prevent same from reaching the detector in the ICD 12. It can be appreciated that the inclusion of a filter can be preferable if excitation light intensity is substantially (e.g., orders of magnitude) higher than that of light emitted by the phosphor, as discussed in greater detail below. The illumination system 16 can include a number of light sources such as LEDs 26 for emitting high-intensity visible light or ultraviolet (UV) light. The LEDs 26 can emit light having wavelengths of, for example, between approximately 380 nm to approximately 450 nm.

It can be appreciated that other ICDs 12, which may have different architectures and/or working mechanisms, can also be used. Additionally, other narrow band illumination systems including, but not limited to, lasers, vertical-cavity surface-emitting lasers (VCELs), and high pressure gas bulbs with notch filters can be used to illuminate the phosphor coating,

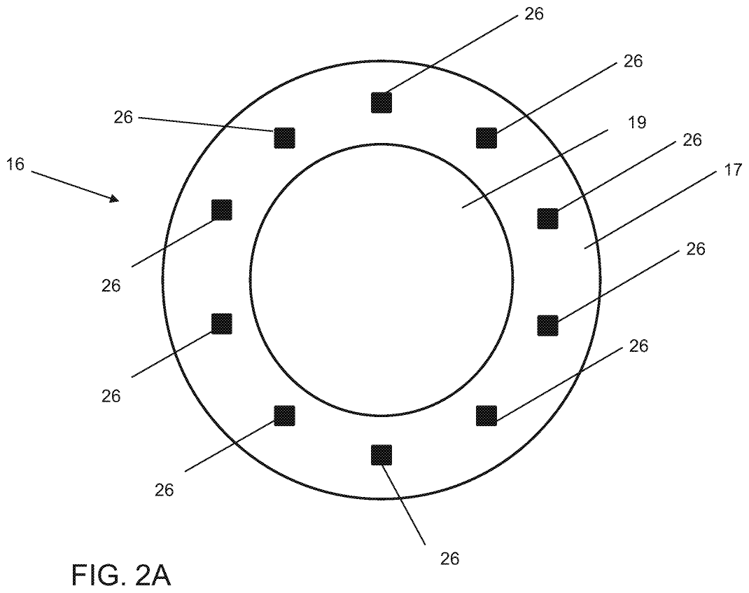

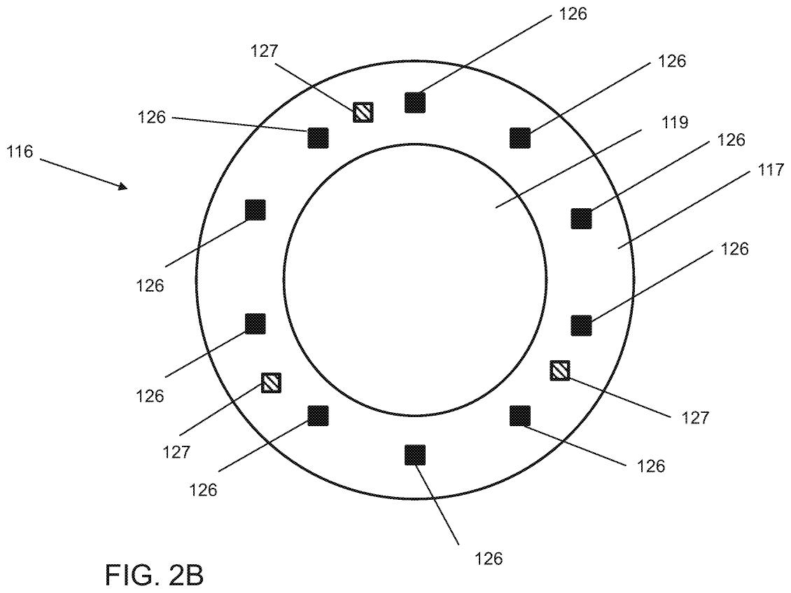

As shown in FIG. 2A, the illumination system 16 includes an annular portion 17 which can include a printed circuit board (PCB) on which the LEDs 26 can be located. An aperture, passage, or hole 19 within the annular portion 17 can be adapted to receive and connect to the ICD 12, thereby physically integrating the illumination system 16 with the ICD 12. The location, intensity and/or output distribution pattern of light emitted from the LEDs 26 can be tuned to, for example, provide uniform illumination over the surface of the phosphor coating 20.

FIG. 2B illustrates an illumination system 116 similar to that shown in FIG. 2A. Similar features are therefore identified with the same reference characters, but with the prefix “1” added. In addition to a number of LEDs 126, the illumination system 116 in this example includes at least one (preferably a plurality of) light intensity detectors 127 provided on the annular portion 117. Such detectors 127 can be sensitive mainly to the wavelengths emitted by the phosphor 20, and can enable a control system to determine if the light emitted by the phosphor is of sufficient intensity for the ICD 12 to begin capturing images, as discussed in greater detail below.

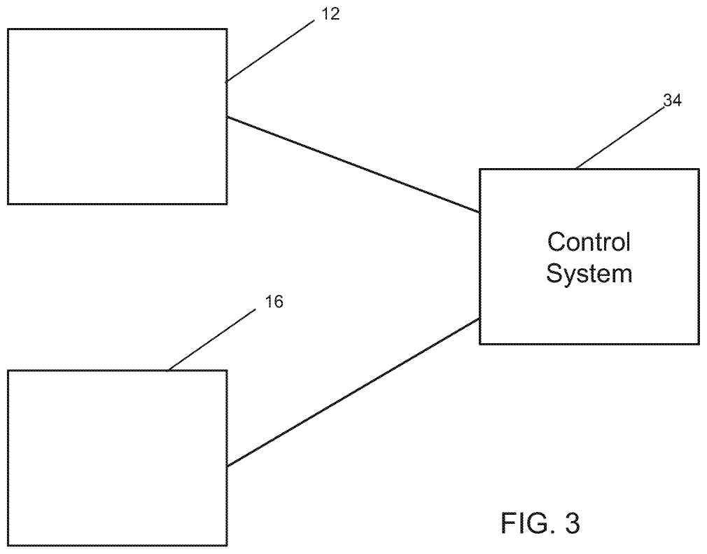

Turning to FIG. 3, a control system 34 can be included in the system 100 to provide and receive signals to and from, respectively, the illumination system 16 and the ICD 12. In this example, the control system 34 is shown as being separate from the analysis system 10 for ease of illustration. Optionally, the illumination system 16 can be integrated physically into the control system 34 and/or the control system 34 can include or be integrated with the data analysis system 10. The control system 34 can include an LED driver, or drive circuit and thus can provide energy control to the illumination system 16 to, for example, tune the intensity of light emitted from the LEDs 26 as mentioned above. The control system 34 can simultaneously control the ICD 12 and illumination system 16 to capture 2-D images that accurately reflect the temperature of the phosphor coating 20, and that require relatively short post-processing times. The LED driver can use constant current or constant voltage topologies. The control system 34 can include suitable circuitry to perform the intended operations and can be suitably interfaced with external hardware. The control system 34 can include other known elements to ensure reliable operation including, but not limited to, microprocessors, microcontrollers, FPGA, DC-DC converting elements, and current limiting and light strobe topologies.

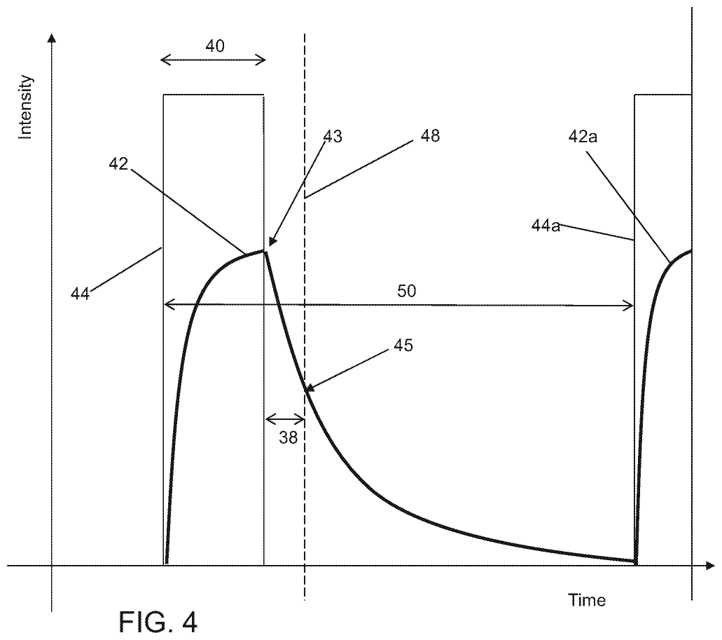

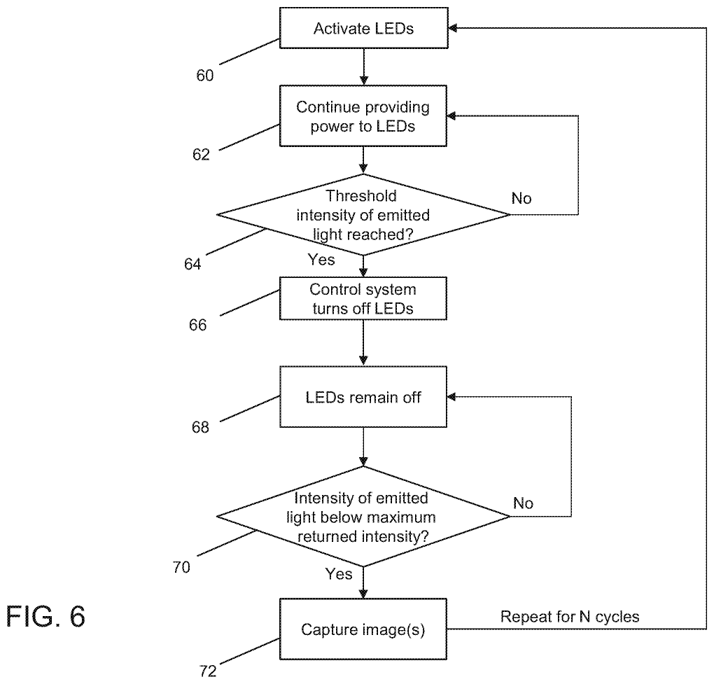

FIG. 4 illustrates a graph depicting intensity of light 42 and 42a emitted by the phosphor coating 20, resulting from LED light pulses 44 and 44a, respectively. The intensities of the LED light pulse 44a and resulting emitted light 42a are depicted solely to illustrate a second repetition of the cycle discussed with respect to FIG. 6, and thus are only partially shown. As shown in the graph, the LED light pulse 44 causes the phosphor coating 20 to luminesce, more particularly to phosphoresce and thereby emit light 42. The emitted light 42 increases in intensity until the LED light pulse 44 ends (i.e., throughout the duration of the LED pulse time 40). At the end of the LED light pulse 44, the emitted light 42 can be at a “threshold returned intensity” 43, the significance of which is explained further below. After the LED pulse duration 40, the phosphor coating 20 continues to luminesce, but with decreasing intensity. After the LED light pulse 44 ends, the ICD 12 can capture multiple images, at a high frame rate, at a trigger time 48. The duration of the trigger time can be very short and can vary based on the frame rate of the high speed camera in the ICD 12 being used and/or the number of images desired. The time period between the end of the LED light pulse 44 and the trigger time 48 is referred to herein as a trigger delay time 38. At the trigger time 48, the emitted light 42 can be of a “maximum returned intensity” 45, as further discussed below.

It can be appreciated that the trigger delay time can optionally have a negative value (i.e. to occur prior to the completion of the LED light pulse 44). Such a negative trigger delay time could be desirable if there exists an intrinsic delay in the operation of the camera or other imaging device used with the control system 34.

It has been shown from experimental trials that the performance of the system 100 (e.g., measurement accuracy and data analysis speed) can depend on the intensity of the light received by the ICD 12. Thus, a desirable threshold intensity of emitted light, or threshold returned intensity can be established for certain operating conditions (e.g., the type of thermographic phosphor used, the involved temperatures etc.). It can be appreciated that the maximum returned intensity 45 level can, in some cases, be the same as the threshold returned intensity. As discussed in greater detail below, maximum returned intensity 45 and threshold returned intensity can be programmed into the control system 34 such that temperature measurements are calculated from consistent emitted light intensity ranges.

Thus, the trigger time 48, which is positive in this example, can be used to allow the emitted light 42 to fall below the maximum returned intensity 45. After the trigger time 48, the emitted light 42 continuously decreases in intensity until the intensity reaches zero or nearly zero and/or until the next LED pulse 44a begins. The time period between LED pulses 44 and 44a is referred to as a cycle time, or frequency of operation 50. It can be appreciated that reaching the threshold, or minimum returned intensity can be of particular importance since low emitted light intensities can result in low signal to noise ratios, reducing temperature measurement accuracy, or preventing the ability to accurately measure at all. In the absence of a filter, timing alone could be used to prevent saturation of the detector in the ICD 12, in which case maximum returned intensity would correspond to the saturation intensity of the detector. However, this is unlikely to occur practically since returned light intensity will generally be orders of magnitude less than the excitation light from the LEDs.

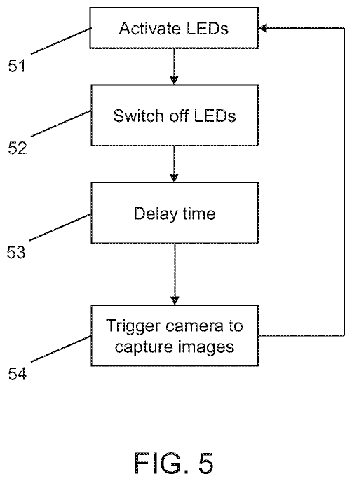

FIG. 5 is a flow chart illustrating a computer executable process for controlling the imaging system 100 using, for example, the control system 34. First, at step 51, the LEDs 26 are activated by the control system 34 (i.e., the control system 34 provides power to the illumination system 16). While power is provided to the illumination system 16, the phosphor coating 20 emits light 42. Next, at step 52, the illumination system 16 is turned off by the control system 34 (step 52), and after the trigger delay time 38 (step 53), the ICD 12 is triggered to capture a number of images (step 54). This process can then be repeated.

Another computer executable process for operating the system 100 using, for example, the control system 34, is shown by the flow chart in FIG. 6. First, at step 60, the control system 34 provides power to the LEDs 26 to generate the LED pulse 44 having wavelengths of between approximately 380 nm to approximately 450 nm. This, in turn, causes the phosphor coating 20 to emit light 42. Next, at step 62, the LEDs 26 remain activated for a time period 40. As shown in FIG. 4, the emitted light 42 increases in intensity throughout the time period 40. At step, 64, if the threshold intensity 43 of emitted light is reached, the process proceeds to step 66 and the control system 34 turns off the LEDs 26. If not, the process returns to step 62. Here, the control system 34 can provide the LEDs 26 with power until the threshold intensity 43 is reached. However, the control system 34 can alternatively and continuously increase the power provided to the LEDs 26 until the threshold returned intensity 43 is reached. At step 64, by controlling the ICD 12, the control system 34 can measure the intensity of the emitted light 42. In particular, the control system 34 can cause the ICD 12 to take a number of images, from which the control system 34 can measure the intensity of the emitted light 42. Alternatively, the control system 34 can measure the intensity of the emitted light 42 using intensity detectors 127 provided on the illumination system 116, as shown in FIG. 2B. After step 66, the process can proceed to step 68 wherein the LEDs remain off for the trigger delay time 38. At step 70, the duration of the trigger delay time 38 can be determined based on whether the intensity of the emitted light 42 is below the maximum returned intensity 45. If the intensity of the emitted light 42 is below the maximum returned intensity 45, the process proceeds to step 72 wherein the ICD 12 captures a number of images, which are processed by the data analysis system 10 (i.e., temperature measurement begins). If not, the process returns to step 68. The process can be repeated for N cycles, where N is an integer selected in accordance with the particular application or environment.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for two-dimensional (2D) thermal imaging of a surface having phosphor thereon, the method comprising:
illuminating the surface with light having an excitation intensity, to induce phosphorescence of the phosphor to generate emitted light;
measuring an intensity of the emitted light;
if the intensity of the emitted light is less than a pre-determined threshold intensity, repeating the illuminating operation, or increasing the excitation intensity and repeating the measuring operation;
if the intensity of the emitted light is equal to or greater than the pre-determined threshold intensity, turning off the light source;
capturing a plurality of images after a delay time and/or when the intensity is less than a pre-determined maximum returned intensity;
calculating, from the plurality of images, a decay lifetime of the phosphor at a number of points on the surface; and
translating the decay lifetime for each point into a temperature to create a 2D thermal image of the surface.

2. The method of claim 1 further comprising:
repeating the method once the intensity is determined to be nearly zero.

3. The method of claim 1 further comprising:
repeating the method after a pre-determined cycle time has elapsed.

4. The method of claim 1, wherein the light is provided by an illumination system comprising a plurality of light sources.

5. The method of claim 4, wherein the plurality of light sources are light emitting diodes (LEDs).

6. The method of claim 1, wherein the intensity of the emitted light is measured using at least one light intensity detector.

7. The method of claim 4, wherein the illumination system is supported by an annular portion facing the surface.

8. The method of claim 7, wherein the annular portion comprises a printed circuit board (PCB) on which the plurality of light sources is provided.

9. The method of claim 7, wherein the annular portion comprises a central passage with which an image capture device (ICD) is aligned to capture the images.

10. The method of claim 1, wherein the surface is illuminated through a window between a source of the light and the surface.

11. The method of claim 10, wherein the window is provided through a wall of a processing chamber, the surface being located in the processing chamber.

12. The method of claim 11, wherein the surface is provided by a semiconductor wafer supported by a chuck.

13. The method of claim 1, wherein a filter is provided between the light and the surface.

14. The method of claim 13, wherein the filter is provided between a lens of an image capture device (ICD) and a window between the ICD and the surface, or between the lens and the ICD.

15. The method of claim 1, wherein the method is performed by an imaging system controlled by a control system, the method further comprising instructing the control system to perform the method.

16. The method of claim 1, wherein the delay time is a positive delay time.

17. The method of claim 1, wherein the delay time is a negative delay time to account for an intrinsic delay in capturing the images.

18. A phosphor thermometry system for carrying out the method according to claim 1, the phosphor thermometry system comprising:
an image capture device (ICD) positioned to capture the plurality of images of the surface;
a computing device configured to receive the plurality of images from the ICD and translate data from the images into a 2-D thermal image;
an illumination system including at least one light source positioned to illuminate the surface;
a control system connected to the illumination system and the ICD, the control system configured to:
determine the intensity of the emitted light by operating the camera;
store and compare the pre-determined threshold intensity and/or the pre-determined maximum returned intensity to the emitted light intensity;
provide power to the illumination system based at least on the intensity of the emitted light; and
operate the ICD to capture the plurality of images.

19. The system of claim 18, further comprising a filter between the ICD and the surface.
